(19) United States
(12) Patent Application Publication
(10) Pub. No.: US 2020/0307790 A1
(43) Pub. Date: Oct. 1, 2020

(54) LIGHT TWIN ENGINE AIRCRAFT

(71) Applicant: Richard Babin, Arnold, MD (US)

(72) Inventor: Richard Babin, Arnold, MD (US)

(21) Appl. No.: 16/369,311

(22) Filed: Mar. 29, 2019

(51) Int. Cl. B64C 39/12; B64D 27/12; B64C 5/02; B64C 25/12; B64C 25/20

(52) U.S. Cl. CPC B64C 39/12; B64D 27/12; B64C 2025/125; B64C 25/12; B64C 25/20; B64C 5/02

(57) ABSTRACT

An aircraft includes a fuselage having a nose end and a tail end and a center of gravity. A primary wing is coupled to the fuselage aft of the center of gravity. A secondary wing is coupled to the fuselage forward of the center of gravity. A v-tail is coupled to the fuselage between the primary wing and the tail end of the fuselage, the v-tail comprising first and second angled stabilizers, each of the first and second stabilizers including a first end fixed to the fuselage and a second free end, distal to the fuselage.

### FIELD OF THE INVENTION

The disclosure is generally directed to twin engine aircraft, and more particularly to twin-engine aircraft that reduce pilot workload and through simplified operation.

### BACKGROUND

Fixed wing aircraft (hereafter “aircraft”) are divided into broad classes based on physical or characteristics or uses. In some cases distinctions between the classes can be blurred. For example amphibious aircraft are capable of operating from both land and sea, and a non-seaplane rated pilot may operate an amphibious aircraft to and from land bases so long the pilot meets all other requirements to fly that specific type of aircraft. A pilot may so operate an amphibious aircraft without a seaplane rating because the seaplane rating provides skills and knowledge specific to water operation and amphibious aircraft—generally speaking—operate no differently than their land-based cousins in land operations. No such ambiguity exists however between the single and multi engine classes. Without a multi-engine rating a pilot cannot operate a multi-engine aircraft in any aspect without an instructor who is appropriately rated him/her self to perform instruction in multi-engine types. This is because conventional multi-engine aircraft require complex skills and knowledge not provided in any type of single engine aircraft training.

On the surface multi-engine light aircraft differ from their single engine counterparts in number of engines. Many multi-engine aircraft are built on the same basic platforms as the single engine counterparts. The numbers, placements, and size/power of the engines are design choices based on many factors that include, but are not limited to, aerodynamic efficiency, structural demands and limitations, build complexity, weight, the weight's effect on the aircraft center of gravity, and operating efficiency. Safety and operating complexity are also concerns. A common design choice is to use piston engines driving tractor propellers or similarly configured turboprop engines, and to provision each engine with just enough power to sustain flight in One Engine Inoperative (OEI) situations, and to place the engines on the wings. This arrangement is commonly believed to be the most efficient because of a conventional aircraft plan-form of a forward main wing and a configuration of tail surfaces aft of the main wing. Amphibious multi-engine aircraft commonly employ thee conventional aircraft plan-form as well.

Conventional multi-engine light aircraft require special training because of inherent limitations in their design. Light aircraft are generally considered to weigh less than 19,000 lbs. The placement of the engines in or on the wing dictates that the propellers be arranged ahead of the center of gravity (CG). The location of the CG and it's relation to forces affecting the aircraft is important because an aircraft in flight will rotate around the CG. For example if the pilot changes the nose pitch up to begin a climb the portion of the aircraft forward of the CG will indeed move up; however, the portion of the aircraft aft of the CG will rotate downward. By placing the engines at or ahead of the CG the aircraft is subject to significant adverse yaw (left or right) forces in OEI due to asymmetric thrust. Designing the tail of a multi-engine aircraft with wing mounted propellers requires tradeoff and compromise for safe OEI operation.

In addition to asymmetric thrust, conventional designs also suffer from asymmetric lift in OEI. Aircraft wings generate lift proportional to the amount of air flowing over them. The operational propeller in a wing mounted puller configuration moves highly energized air over the top and bottom surfaces of the wing while the other wing, with the inoperative engine, has only the forward motion of the aircraft to generate air flow. This effect creates an adverse roll moment due to adverse lift that aggravates the adverse yaw moment.

Combined the adverse forces in conventional aircraft OEI can lead to a loss of aircraft control. As the aircraft airspeed decays, the control surfaces, which are dependent on airflow just like the wings, lose the ability to create forces necessary to resist the adverse forces created by the loss of thrust from one engine. Eventually the aircraft reaches a point where the control surfaces are no longer capable of creating sufficient force to counteract the adverse forces, and the aircraft will roll and/or yaw uncontrollably, eventually causing the wing without power to develop a stall where it generates no effective lift.

Conventional multi-engine aircraft generally have poor spin recovery capabilities. National Aviation regulatory bodies, such as the Federal Aviation Administration (FAA), recognize this fact and often do not require multi engine designs to be spin tested for certification. For example, the FAA has instead designated required testing to determine safe operation speeds for normal and OEI operation that are not found in single engine training. This puts the onus for safe operation of these designs squarely on the pilot. As expected, this creates a need for twin engine aircraft designs with similar performance to the conventional plan-form with simplified operation to enhance operational safety.

Unconventional multi-engine aircraft exist and have had various levels of success addressing the adverse conditions above. In-line multi-engine aircraft (sometimes referred to as “centerline thrust) sacrifice some combination of fuselage volume, engine cooling, and pitch stability to reduce the adverse effects of engine failure. Canard aircraft have had the greatest success in efficiently, but inherent limitations in that plan-form means these aircraft require large ground infrastructure such as long, paved runways.

Seaplanes are fixed wing aircraft that are capable of taking off and landing upon water and fall into two broad categories, flying boats and conventional land-based aircraft with floats or pontoons mounted to the landing gear structures. In flying boats, the lower part of the fuselage is shaped like a boat hull, which, at rest and at low speeds, provides buoyancy and stability. Some flying boats include wing mounted sponsons for added waterborne stability. Conventional land planes that are mounted on floats in place of, or in addition to, conventional landing gear and are commonly referred to as float planes.

A seaplane that is equipped to operate from land or water is referred to as amphibious. Due to the flexibility, amphibious aircraft are designed to operate from unimproved runways and to safely handle beaching and soft terrain, as well as landing on water. Amphibious seaplanes typically serve remote and undeveloped areas. Amphibious float planes typically mount retractable landing gear in or on the floats, the landing gear being retracted for flight and water operation and extended for land operations. Amphibious flying boats are similarly equipped with landing gear mounted in or on the fuselage or wings.

When operating on water, float planes and amphibian planes typically use a float shape that stabilizes the aircraft at rest and generates hydrodynamic lift at speed to aid during take-off. Float planes and amphibian planes are typically constructed with a step-shaped fuselage so that at a designed transition speed on the water the wetted surface of the float moves forward. A conventional float shape has a V-shaped bottom surface to reduce water impact loads. While aiding in separation from water's surface tension the step-shaped fuselage produces aerodynamic penalties when airborne.

Single and multi-engine land-based aircraft and amphibian aircraft generally use two types of landing gear, conventional or tricycle. The landing gear is typically carried on fixed or articulated mounts. Articulated landing gear may be repositioned, moved from the landing position but still exposed, or retracted for different phases of flight. A conventional landing gear design includes of a pair of main wheels and a tailwheel located aft of the main wheels. This type of landing gear may be beneficial when operating in remote areas because it is better able to accommodate rough terrain and unimproved fields. Tricycle landing gear includes a pair of main wheels located on each side of a centerline behind the plane's center of gravity with a nose wheel mounted forward of the main wheels. A tricycle arrangement is less robust than a conventional landing gear but tricycle gear is easier to operate on the ground and during take-off.

The location of the main landing gear for land-based aircraft, and consequently the conventional location of the step in a step-shaped fuselage, is affected by factors that include location of the most aft center of gravity (CG). For example, with tricycle landing gear, the landing gear main wheels are positioned behind the CG. This arrangement provides stability throughout the design performance envelope. More specifically, the CG remains forward of the main wheel contact point. Many conventional float designs place the step at approximately the same position as one would mount the main landing gear, which is problematic for main wheel placement. Amphibians with retractable landing gear place the step at approximately the same position where an ideal location for the main landing gear, which causes the main landing gear to be located further aft than ideal. By locating the main landing gear further aft then ideal, the aircraft is more difficult to rotate on take-off, sometimes referred to as being nose heavy. This problem is caused by the longer distance between the main landing gear and the CG, than would otherwise occur with a conventional aircraft. This added length increases the force needed for rotation, which requires more elevator deflection, speed, or both, before the aircraft can be rotated to the proper angle of attack for takeoff. Further, once the proper factors are achieved rotation is relatively abrupt, which requires pilot awareness to prevent a take-off stall or damaging the aircraft by striking the tail section.

Positioning the step relative to the main wheels also complicates water landings. Optimizing main wheel location over step location produces less waterborne stability that requires constant pilot attention after touchdown to keep the aircraft balanced on a single point, i.e., the step itself, until the hull or floats transition from planing to hull displacement.

In some instances, amphibious seaplanes may also land and takeoff from surfaces other than water, such as snow, wet grass, marshy areas, or other unimproved surfaces. In an emergency, these planes may be required to land and takeoff on soil or even pavement. In these situations, the conventional V-shaped bottom has a tendency to dig into the surface, impeding the ability of the aircraft to separate from the surface on which it is moving.

As discussed above, although jet and turbine powered light airplanes and seaplanes exist, because of the need to reduce complexity and the inefficiency of small jet engines, small seaplanes typically feature one or more combustion power plants to each of includes a single propeller. The propeller can be placed in either forward “tractor” or aft “pusher” configuration. Tractor designs place the propeller(s) forward in undisturbed air and are more efficient than pusher designs, but tractor designs generate, and are vulnerable to, corrosive water spray. Pusher propellers offer better visibility and are easier to shield from spray, but are subject to excessive wear from turbulent flow and generate excessive noise.

Generally, tractor propellers are preferred but the realities of small seaplane design often dictate a pusher configuration. In all cases powerplants and propellers must be kept clear of water. This usually dictates high thrust lines at or above the fuselage roof. This has become an expected characteristic of seaplane operation and most designs compensate through pilot training.

Both land and sea multi-engine aircraft benefit from redundancy of critical systems. As explained above, while few are designed to sustain normal operation in the event of an engine failure they are designed to achieve a certain minimum flight capability in such circumstances. One solution is to affix the engines along the aircraft's longitudinal (fore-to-aft) axis. These aircraft are referred to as “in-line”. This improves single-engine handling by normalizing operation in an engine out scenario. This also requires a combination of tractor and pusher configurations with the strengths and weaknesses of both. Further, these aircraft require pilots to hold a multi-engine rating but pilots who train on in-line aircraft are explicitly limited to in-line or single-engine aircraft operation.

Because of the challenges presented by multi-engine design more and more modern aircraft designers are decreasing the number of engines. High performance single engine light aircraft dominate both sales and production of light aircraft. However, single engine designs are vulnerable to engine failure with no backup source of power. In fact, light single engine airplanes often include engine loss recovery systems, such as ballistic parachutes. Operation over hazardous terrain, at night, and high intensity operations, are all are areas where multi-engine aircraft provide an additional safety layer inherent in having multiple engines. In other words, a single engine failure on a multi-engine aircraft does not require an immediate landing, where even high performance singles are forced to land immediately (e.g., over mountainous terrain or over water) with an engine loss. For this reason, large commercial airplane operators almost exclusively operate multi-engine aircraft for the added safety of the second (or more) engine.

There is a need for a simple to operate, stall and spin resistant, multi-engine aircraft with docile OEI characteristics capable of small and unimproved field operations. There is additional need for such an aircraft which is capable of conversion to amphibious operations without significant degradation of capabilities or changes in operation.

### SUMMARY

In accordance with one exemplary embodiment, an aircraft includes a fuselage having a nose end and a tail end and a center of gravity. A primary wing is coupled to the fuselage aft of the center of gravity. A secondary wing is coupled to the fuselage forward of the center of gravity. A v-tail is coupled to the fuselage between the primary wing and the tail end of the fuselage, the v-tail comprising first and second angled stabilizers, each of the first and second stabilizers including a first end fixed to the fuselage and a second free end, distal to the fuselage.

In accordance with another exemplary embodiment, a flight control input mixer for a twin engine v-tail aircraft includes a base, a trunk rotatably coupled to the base, and an actuator pivotably coupled to the trunk. The actuator includes a body having a first leg and a second leg extending outward from the body proximate the trunk, and a first arm and a second arm extending outward from the body distal to the trunk. A roll input connection is located on the body, and a pitch input connection is located on the body.

In accordance with yet another exemplary embodiment, a landing gear for an amphibious aircraft includes a main strut, a wheel link connected to the main strut, the wheel link having a wheel connection that is configured to accept a wheel, a stabilizer bar connected to the main strut and to the wheel connection, and a ski. The ski has a front portion that is substantially planar and a rear portion that is substantially planar, the front portion and the rear portion being angled relative to one another. The front portion and the rear portion form an angle greater than 0 degrees but less than 45 degrees.

The foregoing embodiments may be combined with any one or more of the following aspects as well with other aspects and/or additional aspects, arrangements, features, and/or technical effects that are apparent upon detailed inspection of the Figures and the following description.

In one aspect, a first engine is coupled to the second end of the first stabilizer and a second engine coupled to the second end of the second stabilizer.

In other aspect, the first engine includes a first propeller and the second engine includes a second propeller, the first and second propellers being oriented in puller configuration.

In yet other aspects, a first ruddervator is coupled to the first stabilizer and a second ruddervator is coupled to the second stabilizer.

In yet other aspects, a flight control mixer is operatively connected to each of the first and second ruddervators.

In yet other aspects, the aircraft is amphibious, and the fuselage includes channels on each side of a lower portion of the fuselage, beginning aft of the secondary wing and merging aft of the primary wing to form a single channel.

In yet other aspects, a water rudder is coupled to an underside of the fuselage, aft of the primary wing.

In yet other aspects, a first yaw input is operatively connected to the first leg and a second yaw input is operatively connected to the second leg.

In yet other aspects, a first ruddervator output is connected to the first arm and a second ruddervator output is connected to the second arm.

In some aspects, the roll input comprises a socket.

In yet other aspects, the body is distal to the roll input and is pivotable about the roll input.

### BRIEF DESCRIPTION OF THE DRAWINGS

FIG. 1 is a perspective view of a light twin-engine aircraft that is constructed in accordance with the teachings of the disclosure.

FIG. 2 is a front elevational view of the aircraft of FIG. 1.

FIG. 3 is a rear elevational view of the aircraft of FIG. 1.

FIG. 4 is a top plan view of the aircraft of FIG. 1.

FIG. 5 is a bottom plan view of the aircraft of FIG. 1.

FIG. 6 is a left side view of the aircraft of FIG. 1.

FIG. 7 is a front view of a control input mixer that is implemented in the aircraft of FIG. 1.

FIG. 8 is a side view of the control input mixer of FIG. 7.

FIGS. 9A-9C are schematic representations of the control input mixer of FIG. 7 and the operation of left and right ruddervators in level flight (e.g., zero degrees of roll).

FIGS. 10A-10C are schematic representations of the control input mixer of FIG. 7 reacting to a roll input and the operation of the left and right ruddervators in banked flight (e.g., greater than zero degrees of roll).

FIG. 11 is a side view of a main landing gear of the aircraft of FIG. 1 in a fully extended, fully loaded configuration.

FIG. 12 is a side view of the main landing gear of FIG. 12 in a fully extended, unloaded configuration, illustrating an angle of ski travel.

FIG. 13 is a front view of the landing gear of FIG. 11.

FIG. 14 is a front view of the landing gear of FIG. 12 in a fully retracted configuration, illustrating main gear tire rotation of 90 degrees when fully stowed in a wheel well.

### DETAILED DESCRIPTION

Generally, a multi-engine aircraft that is constructed in accordance with the teachings of the disclosure includes at least one fuselage of modified tadpole longitudinal cross section with a center of gravity (CG), a forward end, an aft end, left and right undersides formed into fluid flow directing channels, a main wing mounted low on the aft of the CG on the fuselage, a forward wing mounted on the fuselage at or near the vertical midpoint ahead of the CG, and a V-tail empennage mounted on the fuselage aft the main wing, which merges the fluid directing channels. Two tractor propeller power plants are coupled to the distal ends of the empennage, and a retractable tricycle landing gear system is coupled to the fuselage. In various embodiments the aircraft is operable on land, water, snow, or soft terrain. The disclosed aircraft fuselage provides payload volume as well as the attachment structure for the forward wing, main wing, empennage, and forward landing gear. Avionics and accommodations for crew and passengers are also contained therein.

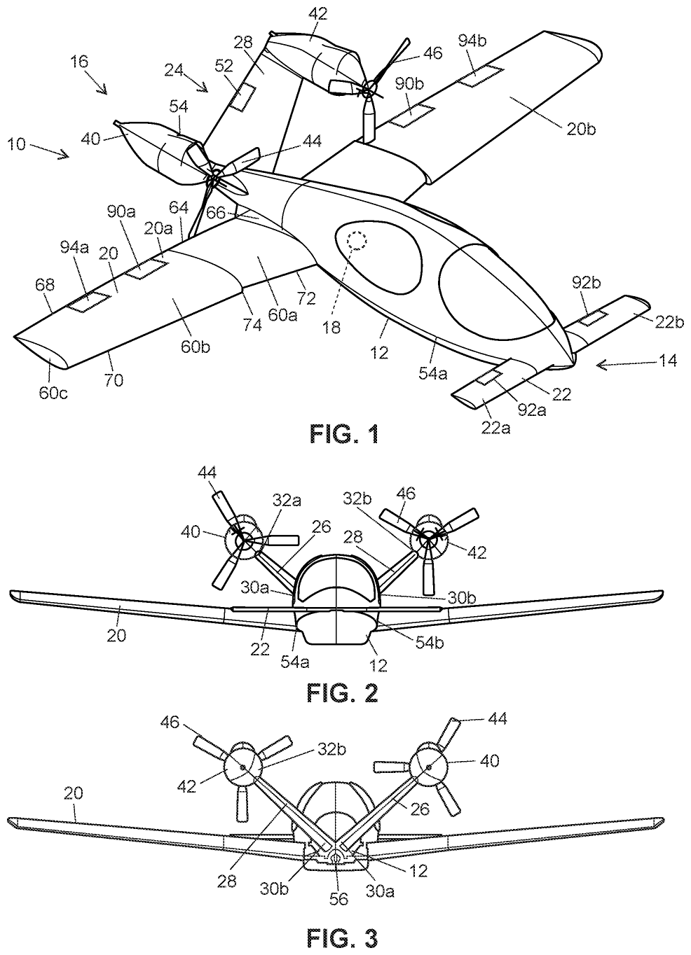

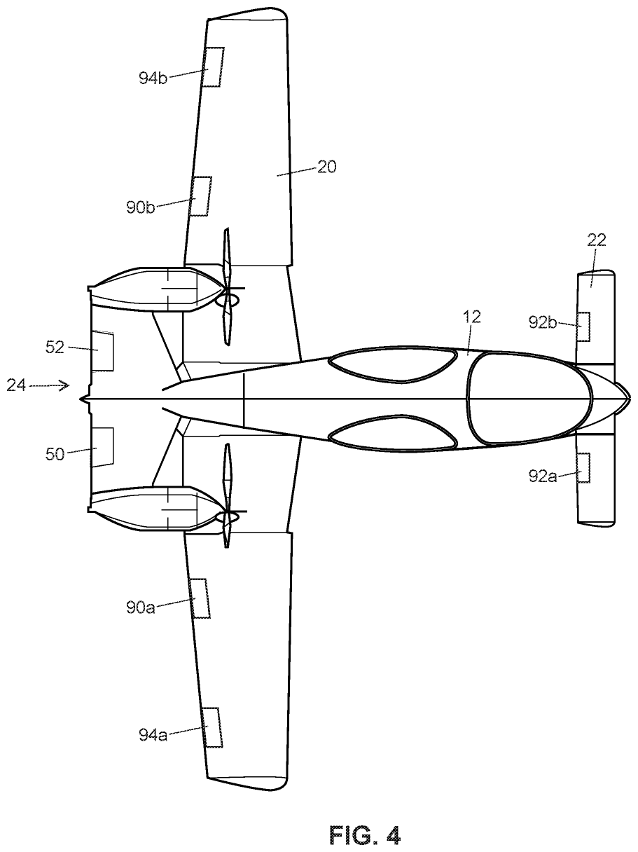

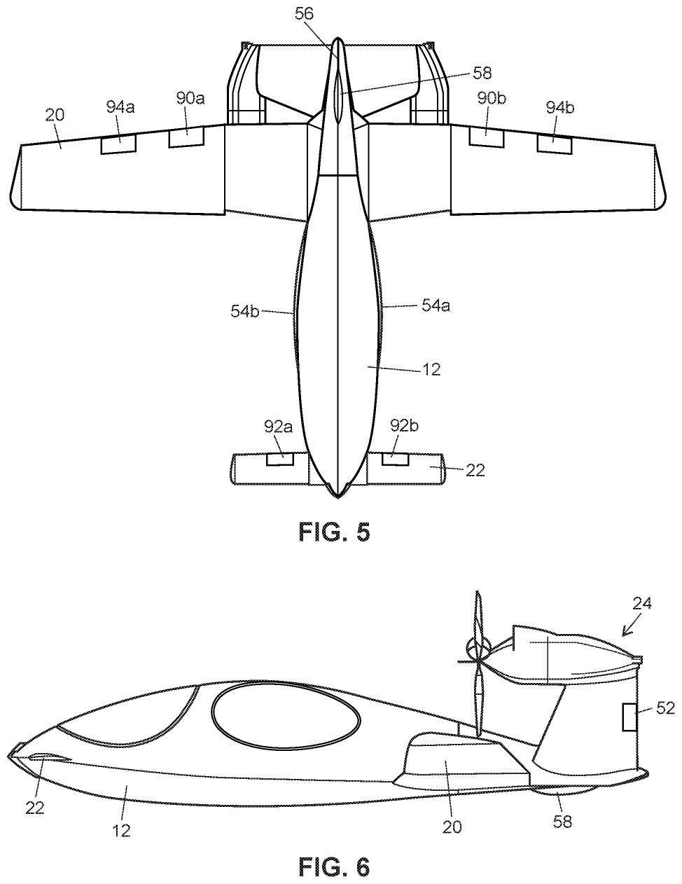

Turning now to FIGS. 1-6, an aircraft 10 comprises a fuselage 12 having a nose end 14 and a tail end 16 and a center of gravity 18. A primary wing 20 is coupled to the fuselage 12 aft of the center of gravity 18. In the illustrated embodiment, the primary wing 20 includes two airfoils 20a, 20b, each attached to one side of the fuselage 12. A wing box (not shown) may extend through the fuselage 12 to connect the two airfoils 20a, 20b to the fuselage 12, for structural rigidity. In other embodiments, the two airfoils 20a, 20b may be separately mounted to the fuselage in a cantilever configuration. A secondary wing 22 is coupled to the fuselage 12 forward of the center of gravity 18. Like the primary wing 20, the secondary wing 22 may include two airfoils 22a, 22b. A v-tail 24 is coupled to the fuselage 12 between the primary wing 20 and the tail end 16 of the fuselage 12. The v-tail 24 includes a first angled stabilizer 26 and a second angled stabilizer 28. Each of the first and second stabilizers 26, 28 includes a first end 30a, 30b fixed to the fuselage 12 and a second free end 32a, 32b, distal to the fuselage 12.

A first engine 40 is coupled to the second end 32a of the first stabilizer 26 and a second engine 42 coupled to the second end 32b of the second stabilizer 28. The first engine 40 includes a first propeller 44 and the second engine 42 includes a second propeller 46, the first and second propellers 44, 46 being oriented in puller configuration. In other words, the first and second propellers 44, 46 are located forward of the respective engine 40, 42 (e.g., towards the nose end 14 of the fuselage 12).

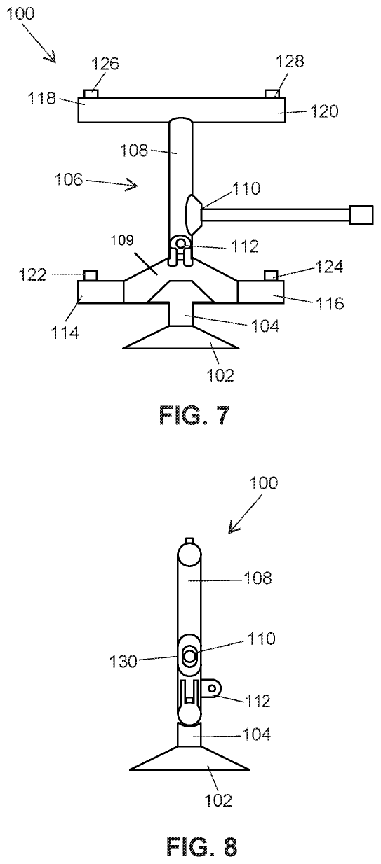

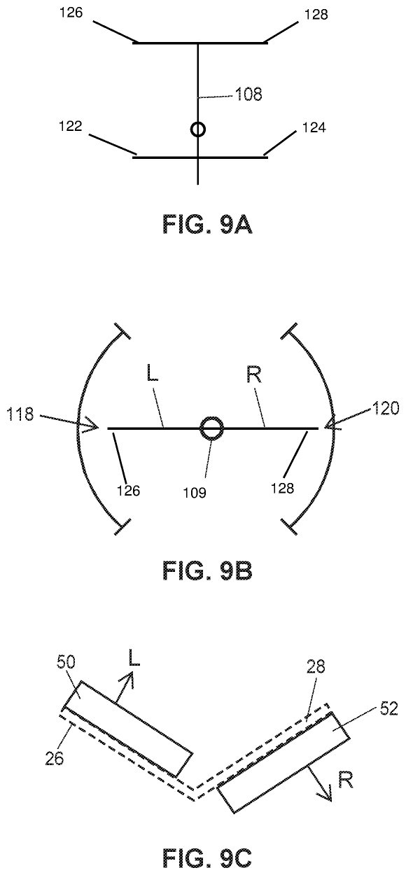

A first ruddervator 50 is coupled to the first stabilizer 26 and a second ruddervator 52 is coupled to the second stabilizer 28. The first and second ruddervators 50, 52 react to pilot control inputs to generate pitch and yaw forces to control the aircraft 10 during flight and ground operations. A flight control mixer 100 (FIGS. 7-10) is operatively connected to each of the first and second ruddervators 50, 52, which translates both control yoke/stick movements and rudder pedal movements into the appropriate first and second ruddervator 50, 52 movement to produce desired control forces.

In the aircraft 10 in the illustrated embodiment, the fuselage 12 includes steps or channels 54a, 54b on each side of a lower portion of the fuselage 12. The channels 54a, 54b begin aft of the secondary wing 22, run longitudinally along the fuselage 12, and merge together aft of the primary wing 20 to form a single empennage channel 56. A rudder 58 is coupled to an underside of the fuselage 12, aft of the primary wing 20. The rudder 58 is movable through connections to rudder pedals. The rudder 58 is reinforced to aid in steering the aircraft 10 during water operations, much like a ship or boat rudder in amphibious embodiments.

Turning now to FIGS. 7-10, the flight control input mixer 100 includes a base 102, a body 104 rotatably coupled to the base 102, an actuator 106 including a trunk 108 pivotably coupled to the base 104, a roll input 110 connection located on the trunk 108; and a pitch input 112 connection located on the trunk 108.

The body 104 includes a first leg 114 and a second leg 116 extending outward from the body 104 proximate the trunk 104, and a first arm 118 and a second arm 120 extending outward from the body 104 distal to the trunk 104. A first yaw input 122 is operatively connected to the first leg 114 and a second yaw input 124 is operatively connected to the second leg 116. A first ruddervator output 126 is connected to the first arm 118 and a second ruddervator output 128 is connected to the second arm 122. A saddle 109 pivotably connects the trunk 108 to the body 104.

In some embodiments, the roll input 110 may comprise a socket 130. The body 108 distal to the roll input 110 is pivotable about the roll input 110.

As a typical V-tail aircraft rolls about a longitudinal axis, the ruddervator located in the direction of the roll gets closer to the plane of the horizon, and begins to project the nose more directly toward the ground or skyward. As the V-tail aircraft rolls, the forces produced by the ruddervators begin to adversely affect controllability because a given input no longer acts in the original plane. For example a ruddervator input to the more horizontally oriented ruddervator in a tight turn would tends pitch the nose of the aircraft downward, thereby inducing a spin attitude. Similarly a rudder input in a slip maneuver tends to pitch the nose skyward in what is already a very high drag maneuver. Pilots need to be trained for these adverse effects and learn to compensate with elevator inputs.

The disclosed flight control mixer advantageously automatically compensates for the problem described above because the net deflection realized through the ruddervator mixer is to decrease the travel of the ruddervator at or nearer to horizontal, thereby decreasing the adverse forces produced by the horizontal ruddervator.

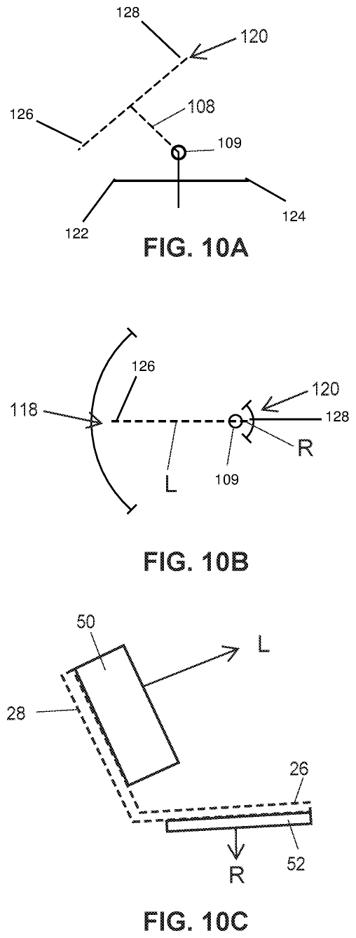

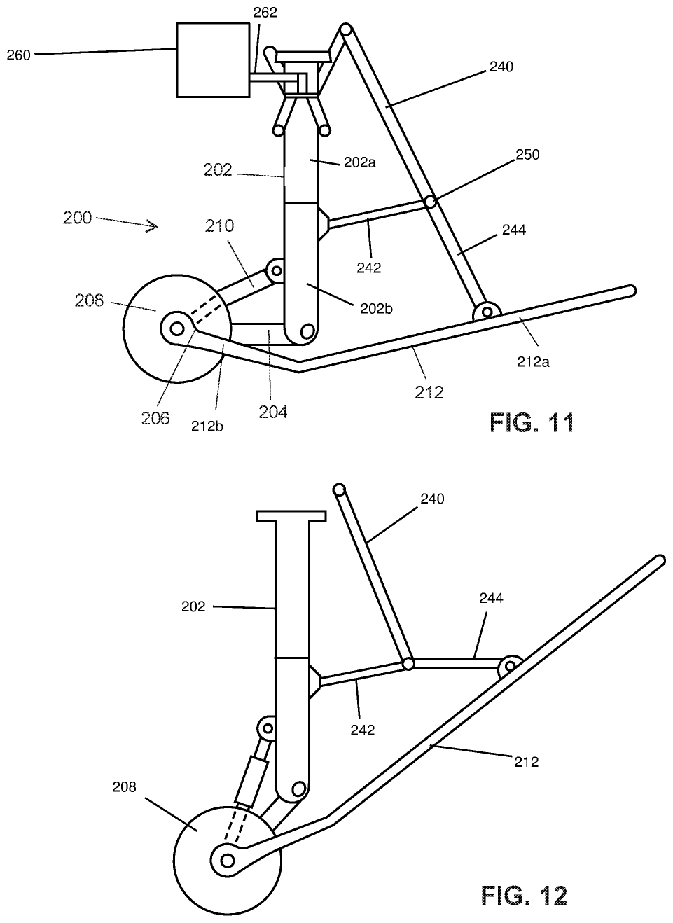

The disclosed flight control mixer 100 decreases adverse forces by adding the roll-input 110. The body 108 of the flight control mixer 100 pivots about a point that is located above the plane of rotation of the trunk 104 such that the body 108 rolls in a direction opposite of the aircraft roll. For example, if the aircraft rolls left for a standard left turn then both the left wing and the left ruddervator descend but the left side of the flight control mixer 100 rises. The motion of the flight control mixer 100 puts its elevated end closer to or directly over the point of rotation (i.e., the point of rotation between the trunk 104 and the base 102). As the elevated side of the body 108 approaches the center of rotation a travel arc in response to rudder input is reduced (see FIGS. 10A-10C). Shorter travel means less response by the ruddervator. Since the elevated side of the flight control mixer 100 controls the ruddervator that is lower as the angle of roll increases the ruddervator closer to horizontal begins to reduce rudder input and behave more as strictly as a conventional elevator. The net result is an aircraft with a V tail that behaves like a traditional cruciform tail aircraft in roll attitudes approaching 45 degrees.

In some embodiments, the disclosed aircraft is sized to accommodate a single pilot and up to 7 passengers and personal cargo. In such embodiments the length of the aircraft from nose to its aft-most surface may be approximately 18 feet and a projected wingspan may be approximately 38.5 feet. In alternative embodiments these dimensions and personage can change. For example, the aircraft may be scaled up or down proportionally. In other embodiments, the aircraft may be longer or shorter, wider or narrower, require a larger crew or operate totally unmanned, carry fewer or greater numbers of passengers.

The engines include counter-rotating output shafts. In other words, the propellers attached to the engines rotate in opposite directions. Propeller rotation for the left (port) side is counterclockwise when viewed from the front, and clockwise on the right (starboard) side. Such counter rotating propellers locate a descending propeller blade inboard, nearer the aircraft center line to reduce the effect of P factor.

Returning now to FIGS. 1-6, the aircraft 10 includes the secondary or forward wing 22, the primary or main wing 20, and the V-tail 24. The forward wing 22 and main wing 20 are trimmed to generate lifting force when air is flowing over the aircraft 10. The forward wing 22 is trimmed and shaped to react more quickly to changes in airspeed relative to the main wing 20 to provide stall resistance and increased leaver arm to correct control issues due to the relatively close coupling of the main wing 20 and V-tail 24.

When the ruddervators 50, 52 are at the neutral position, the angled stabilizers 26, 28 are trimmed to generate a net downforce in level flight.

The main wing 20 includes a steady dihedral along its span (see e.g., FIGS. 2 and 3. The main wing 20 is divided into three main spanwise sections, an inner section 60a, an outer section 60b, and a tip 60c. The inner section 60a is swept at the root to improve aerodynamics at the fuselage joint and fluid flow when in motion and provides buoyancy in amphibious operation. The trailing edge 64 of the inner section 60a is fairly straight and includes a short, sharply-raked water deflection and fuselage trim section 66 inboard that also serves as a bridge between the fuselage 12 and empennage flow directing channels (i.e., the channels 54a, 54b, and 56).

The trailing edge 64 of the inner section 60a and a trailing edge 68 of the outer section 60b meet flush, but a leading edge 70 of the outer section 60b extends forward of a leading edge 72 of the inner section 60a to form a cuff 74. The cuff 74 compensates for adverse lateral flow from the inner section 60a to the outer section 60b, which can contribute to dutch roll, as well as forward wingtip vortices.

The span of the outer section 60b has the unswept leading edge 70 and the raked trailing edge 68 to increase the aspect ratio and improve efficiency and glide characteristics. The tip section 60c is designed for simplicity; however, other embodiments may feature different shapes or features including but not limited to winglets, up or down turned ends, or fuel tanks.

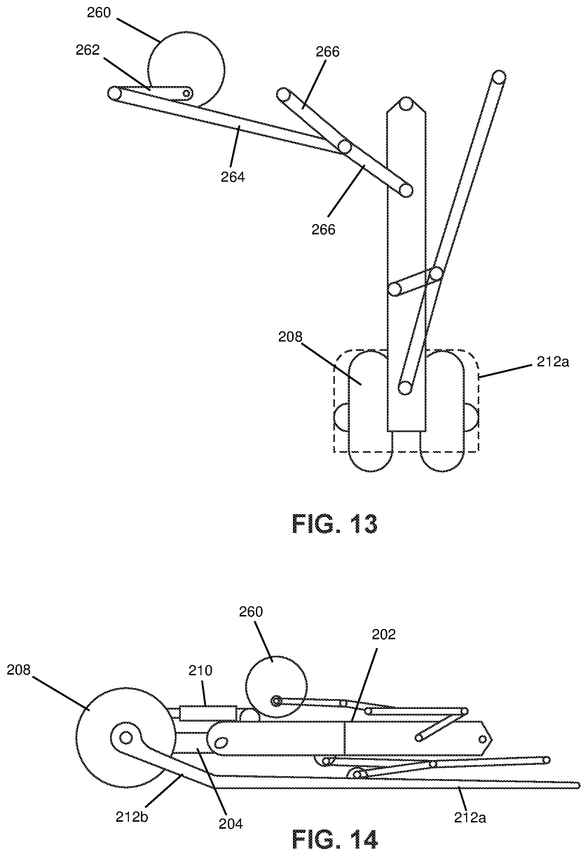

Turning now to FIGS. 12-15, the main wing 20 houses the left and right main landing gear and associated retraction systems. These systems may be electric in nature and may include a motor 260 with swing arm 262, a torque tube 264, and a pair of A-arms 266 arranged to operate in a scissor motion when torque is applied. The A-arms 266 overextend when the gear is deployed to lock the gear in the down position. The main landing gear uses conventional retract system in land-only capable units. The gear retract laterally inward; i.e. toward the fuselage, somewhat parallel to the main wing spar. A main strut 202 rotates 90 degrees such that a lower main gear leg 204 and wheels 208 are in line with a longitudinal axis of the aircraft when deployed and in line with a lateral axis of the aircraft when fully retracted.

Embodiments adapted for amphibious operation use a ski/hydrofoil system that allows the aircraft to operate from water without requiring a change in landing configuration for the gear and high lift devices.

The amphibious landing gear configuration itself includes the main strut 202 having a support strut upper 202a, a main support strut lower 202b, a trailing arm with suspension strut and one or more wheels 208, a hydrofoil ski/door 212, and three secondary support arms 240, 242, 244 arranged to support the hydrofoil ski/door 212. A lower main support leg 204 accommodates rotation of the hydrofoil ski/door 212 from deployed to retracted and vice versa such that the hydrofoil ski/door 212 forms the lower wing skin and main gear door when retracted. A second gear door completes the retracted gear housing. The secondary support arms 240, 242, 244 join each other at a point 250 forward of the main strut 202 between the wing underside (not shown in FIGS. 12-15) and the hydrofoil ski/door 212 when deployed, and below it when retracted. An opposite end of the upper secondary arm 240 is mounted to the wing structure. An opposite end of the central secondary arm 242 is mounted to the lower main gear leg 204. An opposite end of the lower secondary arm 244 is mounted to the hydrofoil ski/door 212. The three secondary arms 240, 242, 244 operate in a scissor-fold action to support the hydrofoil ski/door 212 as it moves with a trailing arm. It is a load-bearing structure.

More specifically, the landing gear 200 for amphibious adaptation of the aircraft includes the main strut 202 and the lower main support leg 204, which is connected to the main strut 202, the lower main support leg 204 having a wheel connection 206 that is configured to accept the wheel 208. An oleo strut 210 is connected to the main strut 202 and to the wheel connection 206. The hydrofoil ski/door 212 has a front portion 212a that is substantially planar and a rear portion 212b that is substantially planar. For example, in one embodiment, the front portion 212a and the rear portion 212b form an angle greater than 0 degrees but less than 45 degrees.

In some embodiments, main wings 20 incorporate extended range fuel tanks internally. In other embodiments, the main wings 20 may have joints where each wing can fold, thereby reducing the size of the aircraft so that it can fit in a constrained space, for example while docked or for transport overland. A wing fold that allows the wing to rotate vertically may be positioned at a location where the loads are small, outboard of 50% of the span, to allow the wing to fold without interrupting the maximum propeller travel arc or propeller disc. In other embodiments the wing fold is set to allow the upturned ends of the wings to frame the propeller disc. In still others the fold joint allows the main wing to fold to a span matching that of the forward wing. In other embodiments the wings may fold in a compound motion to the vertical and fore or aft simultaneously leaving the folded sections parallel the longitudinal axis.

In one embodiment, control surfaces may be included on all three main flight surfaces. For example, in one embodiment, the forward wing 22 may include high-lift devices in the form of trailing edge flaps 90a, 90b. The flaps 90a, 90b may alternately have 2, 3 or more position settings which can include but are not limited to a range of 15 degrees of upward (negative) travel to 40 degrees downward (positive) travel. Negative travel would allow the forward wing 22 to be trimmed to neutral lift during high speed flight at altitude reducing drag and increasing efficiency. Positive travel increases both lift and drag to reduce take-off and landing distances. In other embodiments the forward wing 22 may include an elevator 92a, 92b, which may act as the primary pitch control.

In alternative embodiments, the V-tail 24 may alternately include ruddervators or rudders. Ruddervators may include a more neutral dihedral to allow effective control in both pitch and yaw although the extended lever arm provided by the forward wing 22, thus increasing effectiveness in pitch control.

The main wing 20 outer section 60b trailing edge 68 may include ailerons or alternatively flaperons 94a, 94b. In either case these surfaces move opposite one another to provide the pilot roll control. As flaperons 94a, 94b they move collectively to increase lift and would be deployed in take-off and landing as deemed appropriate and necessary by the pilot. The flaperons 94a, 94b may augment the trailing edge flaps 90a, 90b, or in other embodiments, the flaperons 94a, 94b may provide sufficient low speed lift to replace the trailing edge flaps 90a, 90b. The main wing 20 outer section 60b leading edge 70 may include fixed or retractable slats (not shown). Slats reduce wing stall speed, thereby allowing greater control in slow flight.

In some embodiments the fuselage channels 54a, 54b and the empennage channel 56 are concave forms, in other embodiments, they may be formed by a single centerline keel. Sister keelsons may or may not be affixed in-line with the channels and may or may not replace the concave forms or keel.

In some embodiments a traditional stepped flying boat hull includes left and right edges of the step that begin flush with a filleted edge of the fuselage underside and gradually move aft, increasing in pitch to the centerpoint of the step located ahead of the main wing leading edge at the unloaded CG. The step may or may not be retractable; and, when the step is retractable, the step may optionally deploy simultaneously with the landing gear.

The disclosed aircraft is operable on land, water, snow, or soft terrain.

The disclosed aircraft may land on water by decelerating to the design landing speed and configuring the flaps and the aircraft otherwise for landing. This includes deploying the landing gear which, being equipped with water skis, contacts the water surface first and simulates landing behavior on prepared dry fields. The aircraft first contacts the water at the main landing gear skis while the pilot maintains a nose-high attitude to slow the craft and prevent prematurely making surface contact with the nose ski (this operation is similar to typical dry field landings). After the pilot allows the nose ski to contact the water and allows the aircraft to drop below hydroplaning speed and come to rest on the fuselage reinforced underside. As the aircraft slows, it transitions to hull displacement.

On landing the forward wing 22 aerodynamically mitigates excessive nose-high attitude but, should the aircraft come to rest on the main gear skis and tail or tail-first, the shaped hull advantageously forms below the empennage a contact surface and resists swamping. In this attitude the shaped aft fuselage also increases the nose-down moment on the main gear to raise the minimum hydroplaning speed. If the pilot persists the nose-high approach these features facilitate bringing the aircraft to rest on the water surface without suffering catastrophic damage. Similarly in a nose-down approach the nose ski will contact the surface first and absorb the impact energy allowing the pilot to correct and go-around.

Once in hull displacement mode on water the gear can be retracted for waterborne navigation taxi and docking; however, the landing gear would remain deployed for beaching.

The aircraft may operate on water by surface taxiing. Stability and efficiency are achieved through a combination of aft CG, the aforementioned hull and empennage shape(s), and the wetted main wing. With the ski-equipped landing gear retracted and absent the optional step, or if the step is present and equipped to be retracted, the craft is configured to remain rooted to the surface in navigation taxi to resist upsetting the waterborne balance and reduce pilot workload.

The aircraft my take-off from water. In an embodiment without a step the landing gear must be deployed. In embodiments with a step it is recommended to deploy the gear but a safe take-off can be accomplished with the gear retracted.

In a gear down water take-off, nose-high trim is achieved through a combination of lifting forces generated by the hull, nose gear ski, and forward wing. Once surface speed exceeds taxiing speed the aircraft transitions to a planing regime. The aircraft then completes the take-off as if it were a land-based take-off. Similar to water landings excessive attitudes are mitigated by the design's forward wing and hydrodynamic shapes.

The aircraft may operate with either of the powerplants inoperative with neither engine more critical to safe operation than the other. The aircraft's forward wing design allows for operation in these adverse conditions with minimized stall-spin risk because the forward wing stall speed is above the Vmc minimum safe single engine maneuver speed.

Vmc is further reduced by a paradoxical and unexpected, but favorable effect of mounting the engine on the tail surface. The tail is trimmed to produce downforce to supplement the forward wing and balance the CG forward of the main wing and create dynamic stability. In single engine operation—emergency or otherwise—this downforce is increased asymmetrically, similar to, but opposite of, current piston twin aircraft. The favorable affect is a tendency to roll the aircraft into the operating engine creating horizontal lift components from the forward and main wing that are opposite the adverse yaw generated by the asymmetric thrust.

The described embodiments provide an aircraft with a configuration that is safe, versatile, and efficient, as well as easy to control, highly capable, and which is able to operate from almost anywhere.

Although this description has been provided in the context of specific embodiments, those of skill in the art will appreciate that many alternative embodiments may be inferred from the teaching provided. Furthermore, within this written description, the particular naming of the components, capitalization of terms, etc., is not mandatory or significant unless otherwise noted, and the mechanisms that implement the described invention or its features may have different names, formats, or protocols.

Finally, it should be noted that the language used in the specification has been principally selected for readability and instructional purposes, and may not have been selected to delineate or circumscribe the inventive subject matter. Accordingly, the disclosure is intended to be illustrative, but not limiting, of the scope of the invention.

While various embodiments have been described above, this disclosure is not intended to be limited thereto. Variations can be made to the disclosed embodiments that are still within the scope of the appended claims.

What is claimed:

1. An aircraft comprising:
a fuselage having a nose end and a tail end and a center of gravity;
a primary wing coupled to the fuselage aft of the center of gravity;
a secondary wing coupled to the fuselage forward of the center of gravity; and
a v-tail coupled to the fuselage between the primary wing and the tail end of the fuselage, the v-tail comprising first and second angled stabilizers, each of the first and second stabilizers including a first end fixed to the fuselage and a second free end, distal to the fuselage.

2. The aircraft of claim 1, further comprising a first engine coupled to the second end of the first stabilizer and a second engine coupled to the second end of the second stabilizer.

3. The aircraft of claim 2, wherein the first engine includes a first propeller and the second engine includes a second propeller, the first and second propellers being oriented in puller configuration.

4. The aircraft of claim 1, further comprising a first ruddervator coupled to the first stabilizer and a second ruddervator coupled to the second stabilizer.

5. The aircraft of claim 4, further comprising a flight control mixer that is operatively connected to each of the first and second ruddervators.

6. The aircraft of claim 5, wherein the mixer comprises
a base;
a trunk rotatably coupled to the base;
an actuator pivotably coupled to the trunk, the actuator including a body, the body including a first leg and a second leg extending outward from the body proximate the trunk, and a first arm and a second arm extending outward from the body distal to the trunk.
a roll input connection located on the body; and
a pitch input connection located on the body.

7. The aircraft of claim 1, further comprising a landing gear having
a main strut;
a wheel link connected to the main strut, the wheel link having a wheel connection that is configured to accept a wheel;
a stabilizer bar connected to the main strut and to the wheel connection; and
a ski, the ski having a front portion that is substantially planar and a rear portion that is substantially planar, the front portion and the rear portion being angled relative to one another,
wherein the front portion and the rear portion form an angle greater than 0 degrees but less than 45 degrees.

8. The aircraft of claim 1, wherein the aircraft is amphibious, the fuselage comprising channels on each side of a lower portion of the fuselage, beginning aft of the secondary wing and merging aft of the primary wing to form a single channel.

9. The aircraft of claim 8, further comprising a water rudder coupled to an underside of the fuselage, aft of the primary wing.

10. A flight control input mixer for a twin engine v-tail aircraft, the flight control input mixer comprising:
a base;
a trunk rotatably coupled to the base;
an actuator pivotably coupled to the trunk, the actuator including a body, the body including a first leg and a second leg extending outward from the body proximate the trunk, and a first arm and a second arm extending outward from the body distal to the trunk.
a roll input connection located on the body; and
a pitch input connection located on the body.

11. The mixer of claim 10, wherein a first yaw input is operatively connected to the first leg and a second yaw input is operatively connected to the second leg.

12. The mixer of claim 10, wherein a first ruddervator output is connected to the first arm and a second ruddervator output is connected to the second arm.

13. The mixer of claim 10, wherein the roll input comprises a socket.

14. The mixer of claim 13, further comprising a bell crank connected to the socket.

15. The mixer of claim 14, wherein the body distal to the roll input is pivotable about the roll input.

16. A landing gear for an amphibious aircraft, the landing gear comprising:
a main strut;
a wheel link connected to the main strut, the wheel link having a wheel connection that is configured to accept a wheel;
a stabilizer bar connected to the main strut and to the wheel connection; and
a ski, the ski having a front portion that is substantially planar and a rear portion that is substantially planar, the front portion and the rear portion being angled relative to one another,
wherein the front portion and the rear portion form an angle greater than 0 degrees but less than 45 degrees.
